(19) United States
(12) Patent Application Publication
(10) Pub. No.: US 2018/0230562 A1
(43) Pub. Date: Aug. 16, 2018

(54) VACUUM DEGASSING DEVICE OF PUMP VALVE

(71) Applicant: Yixian DANG, Jinan (CN)

(72) Inventor: Yixian DANG, Jinan (CN)

(21) Appl. No.: 15/751,682

(22) PCT Filed: Aug. 12, 2016
(86) PCT No.: PCT/CN2016/094919

§ 371 Date: Feb. 9, 2018

(30) Foreign Application Priority Data
Aug. 29, 2015 (CN) 201510559061.6

(51) Int. Cl. C21C 7/10; B01D 19/00

(52) U.S. Cl. CPC C21C 7/10; B01D 19/0036

(57) ABSTRACT

A pump valve vacuum degassing device including a receiving funnel, a loading member, a vacuum processing chamber, and a discharging member sequentially connected in a sealed manner and having internal cavities in mutual communication. The receiving funnel can achieve complete and thorough slag avoidance, and does not require any manual control operation. The vacuum processing chamber is provided with a barrier member configured to increase a falling time duration of liquid steel and sufficiently spread the liquid steel, so as to create a more ideal and sufficient condition for removal of harmful gases. The U-shaped structure of the loading member and discharging member ensures maintenance of a vacuum environment during off-time of the device and retaining of airtightness, such that air ingress diminishing a vacuum condition no longer occurs. The device can realize continuous manufacturing in a vacuum.

### TECHNICAL ART

The invention refers to a vacuum degassing device of molten metal, specifically a vacuum degassing device of pump valve for external refining of molten steel.

### BACKGROUND ART

With the development of society and the progress of science and technology, people are demanding higher and higher performance of steel. This requires that the steel-making external refining production must be provided with a higher purity of the molten steel. And the vacuum degassing refining is the most ideal method for degassing, which has been proved by theoretical study and production practice.

Although there are many pieces of equipment used in the vacuum degassing and refining of molten steel, the method adopted is no more than the following: drip method, tank method, DH method and RH method. These technologies and equipment come from abroad. A present, for all current equipment including typical equipment VD, VOD, VAD, DH, RH, ASEA-SKF, LFV and the like, vacuum refining treatment of the molten steel is carried out intermittently by taking steel ladle as the unit. The production process of intermittent production mode is necessary to frequently carry out repeated operation of vacuum breaking and vacuum pumping, this is not only featured with heavy load and high energy consumption, but also the system sealing condition is poor (sealing butt face is large), the vacuum degree is not high; meanwhile, the exposed area and remaining time of the molten steel in the vacuum are very limited, . . . . All these seriously restrict the performance of vacuum efficiency of refining equipment. In particular, while vacuuming, the use of RH also shall be artificially inflated (argon generally). As a result, the cost is wasted and workload of the vacuum pump is also increased. There is a mutually contradictory work consumption situation.

Both the theoretical study and production practice show that the most ideal degassing condition is the suspended drip, and the degassing and refining effect thereof is the best. However, based on the existing problems of the current equipment: \textcircled{1} poor vacuum exposure condition, \textcircled{2} heavy air exhaust load and large superheated steam consumption of steam-jet pump, \textcircled{3} short vacuum remaining time . . . , the current process degassing effect is not ideal and energy consumption is high. Furthermore, the process operation is difficult. As for the steel with high cleanliness requirement, especially the steel that requires deep denuding of N, C and O, the current equipment is obviously not enough. People can only adapt to these stringent requirements through strict material selection and process control, which will undoubtedly push up the cost of refining production and increase the difficulty of process operation. The vacuum effect is not fully utilized.

In short, steel-making external refining production adopts intermittent production mode by taking steel ladle as the unit in the world, and vacuum continuous production has not been realized. The intermittent production mode determines the operation difficulty of the current equipment, the energy consumption is high, and it is difficult to achieve a deeper refining and purification requirement.

### TECHNICAL PROBLEM

The invention is aimed at providing a piece of equipment capable of realizing continuous vacuum refining treatment of molten steel—vacuum degassing device of pump valve. It can solve the existing problems and shortages of the existing vacuum refining equipment.

### SOLUTION TO PROBLEM

### Technical Solution

For realizing the purpose above, the invention adopts the following technical scheme: comprising a receiving hopper, wherein the receiving hopper is of asymmetric and conical structure with an opening at one side, and it is used for discharging the excessive insoluble substances injected from the steel ladle, so as to naturally realize the purpose of separating the insoluble substances from the steel. A lower end of the receiving hopper is connected with the filling body, the filling body is U-shaped and it is a channel for putting the molten steel into the vacuum treatment warehouse through the receiving hopper. Meanwhile, it is also the part of isolating the external atmospheric environment from the vacuum environment of the treatment chamber to realize pressure remaining seal. A tail end of the filling body is connected with an upper part of the vacuum treatment warehouse. The baffle body is set in the inner chamber of the vacuum treatment warehouse, and the lower part thereof is connected with the drainage body. The vacuum extraction opening of the vacuum treatment warehouse is connected with a vacuum pump. The drainage body is a channel for discharging the refining molten steel of vacuum treatment from the vacuum treatment warehouse. The drainage body is U-shaped, its inner chamber is full of motel steel, and then it realizes pressure remaining sealing of the vacuum treatment warehouse together with the filling body. The inner chambers of the receiving hopper, the filling body, the vacuum treatment warehouse and the drainage body are equipped with refractory linings. Electrical heating element is set at the proper position of the lining for heat preservation and concurrent heating to prevent molten steel condensation caused by heat dissipation.

The receiving hopper, the filling body, the vacuum treatment warehouse and the drainage body are orderly and firmly connected together, the inner chambers thereof are also orderly and firmly connected together, and butt joint sealing thereof is ensured.

### ADVANTAGES OF THE PRESENT INVENTION

### Brief Description with Figures

### Description of Drawings

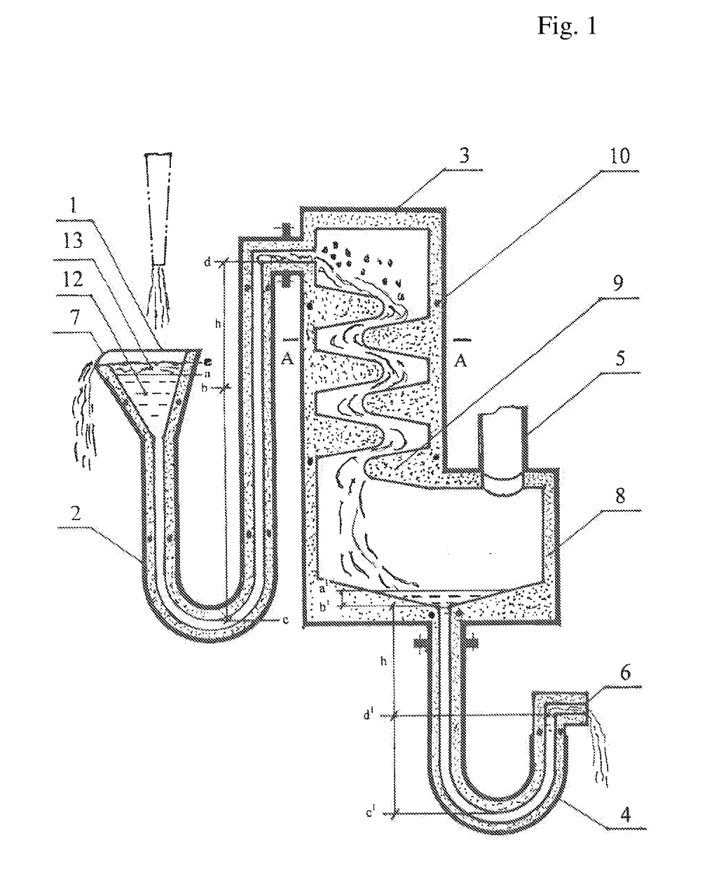

FIG. 1 shows a structure diagram of the invention.

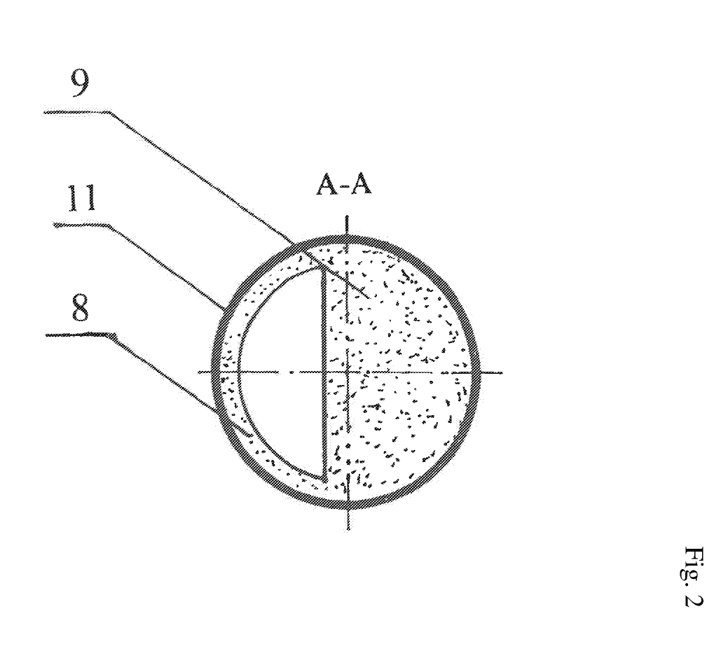

FIG. 2 shows a structure diagram of Section A-A in FIG. 1.

(I) is the meaning of the digits in the figure.

(II) is the meaning of the letters in the figure.

I is the meaning of digits in the figure.

1—receiving hopper 2—filling body 3—vacuum treatment warehouse

4—drainage body 5—vacuum extraction opening 6—outlet of refining molten steel

7—overflow port of insoluble substance 8—refractory lining 9—baffle body

10—electrical heating element 11—shell 12—molten steel 13—insoluble sub stance

II is the meaning of letters in the figure.

a—upper limit of motel steel liquid level: under the filling condition of steel ladle (refining operation industry and mining), the liquid level of the molten steel 12 will be higher than the Point b of the static balance liquid level, and fluctuate in a certain range. This fluctuation can be controlled in a proper range by fit design of the injection flow and flux in the inner chamber of the filling body 2, and it will not exceed a certain limit value. The Point a is determined by the structure and it is the upper limit of the highest liquid level which is ensured by the fit design and can be reached under the maximum filling flow. Overall fit design shall ensure that the motel steel liquid level does not exceed this point under any circumstances, so as to ensure that the upper surface of the molten steel is protected and covered with an insoluble substance layer with enough thickness.

b—molten steel liquid level under the shutdown condition (the vacuum treatment warehouse 3 maintains the vacuum). Because the molten steel approaching side of the filling body 2 is atmospheric environment, and the leading-out side is vacuum environment. Due to the atmospheric pressure, the molten steel liquid level b will be lower than the vacuum absorption and injection position d for a certain height under the shutdown condition, and the following conditions will be satisfied naturally to reach balance and no flow;

P slag+P be molten steel+P atmosphere=P dC molten steel

c—sealing bottom point of U-shaped inner chamber of the filling body 2: As long as the inner chamber of the Point c is always full of molten steel, it can ensure the isolation of the atmosphere and the vacuum environment, and the vacuum treatment warehouse 3 will not have pressure loss.

(1—vacuum absorption and injection liquid level: The pressure intensity provided by the molten steel injection side of the filling body 2 is enough to raise the molten steel at the vacuum side to the Point d only, transferring the molten steel 12 into the vacuum treatment warehouse 3 can be realized to maintain the vacuum degassing refining.

e—position of insoluble substance: The position of Point e is determined by the overflow port 7 of insoluble substance. As long as the vacuum treatment warehouse 3 has no pressure loss and the working vacuum is stable, the position of insoluble substance will be stable at this point. The injected excessive insoluble substances will be discharged from the overflow port 7 of insoluble substance naturally. So, the insoluble substance can be avoided completely and thoroughly, without any manual operation. The thickness of the insoluble substance layer will fluctuate to a certain degree in the running process, but it will not be greater than eb. Due to low density of the insoluble substance, when the thickness of the insoluble substance reaches eb, the insoluble substance injected sequentially will be very natural to be discharged from the overflow port of insoluble substance, so the thickness will not exceed eb.

a 1—upper limit of the molten steel liquid level in the vacuum treatment warehouse 3: Refining degassing molten steel will be gathered here in the running process, so the liquid level will rise. Discharge power will be produced by the static pressure of the molten steel higher than the Point b I, so that the molten steel is discharged from the outlet 6 of refining molten steel through the inner chamber of the drainage body 4. The molten steel can be discharged smoothly through flux design of all parts of the whole part, and it will not be stored too much here, so the molten steel liquid level will not exceed the allowable range. The Point a 1 is the highest molten steel liquid level allowable here under the maximum handling capacity condition (the maximum injection flow of the steel ladle). So it ensures that the inner chamber space of the vacuum treatment warehouse 3 is not occupied by the refining molten steel, and smooth refining treatment is ensured.

bi—static liquid level of refining molten steel under the shutdown condition for replacement of steel ladle (the vacuum treatment warehouse 3 maintains the vacuum).

Adhesion at this moment:

P b molten steel=P Al molten steel+P atmosphere

Namely: P h molten steel=P atmosphere

c—sealing bottom point of inner chamber of drainage body 4: Its function is the same as that of the Point c of the filling body. The inner chambers of the drainage body 4 and the filling body 2 shall be full of molten steel to jointly realize the pressure remaining sealing and no pressure loss of the vacuum treatment warehouse 3.

h—molten steel liquid column height difference formed by vacuum negative pressure: The vacuum liquid column height of the molten steel is h«1.48 m under the condition of working vacuum degree (within 100 Pa). Even the vacuum degree fluctuates within 1,000 Pa, the change value of h will not exceed 1.5 cm, so it can be deemed that the h value is stable.

### Embodiment Mode of the Invention

The vacuum degassing device of pump valve of the invention described in

comprises a receiving hopper 1, wherein the receiving hopper 1 is firmly connected with the filling body 2. The filling body 2 is tightly and firmly connected with the upper part of the vacuum treatment warehouse 3. The vacuum treatment warehouse 3 is tightly and firmly connected with the drainage body 3, and the vacuum treatment warehouse 3 is equipped with a vacuum extraction opening 5, which is connected with a vacuum pump. In the working state, the U-shaped parts of the inner chambers of the filling body 2 and the drainage body 4 shall be filled with molten steel in advance, so as to realize the isolation of the vacuum treatment warehouse and the atmosphere and ensure vacuum extraction.

During refining treatment, as the molten steel to be treated is injected from the steel ladle to the receiving hopper 1, the refining treatment starts. The molten steel 12 injected from the steel ladle is guided from the inner chamber of the filling body 2 to the vacuum treatment warehouse 3. The molten steel is fully broken, rolled and exposed in the vacuum environment of the vacuum treatment warehouse 3 to provide good conditions for removing harmful gas inside thoroughly. The degassing molten steel is gathered at the lower part of the vacuum treatment warehouse 3, put into the inner chamber of the drainage body 4, and discharged from the outlet 6 of refining molten steel, so as to complete the refining process.

The present invention can realize the vacuum continuous production which is not realized in the world now. The manual control operation is unnecessary for refining treatment and shutdown for replacement of steel ladle, and frequent operation of repeated vacuum extraction and vacuum breaking by air inflation is unnecessary; Filling power is also provided by the static pressure of the molten steel naturally, without manual supply or operation. During shutdown for replacement of steel ladle (injection stop), the height difference h (h«1.48 m under the condition of working vacuum degree) between the static liquid level b in the receiving hopper 1 and the vacuum absorption and injection liquid level d will be maintained due to the vacuum negative pressure of the vacuum treatment warehouse 3. Similarly, the height difference h between the static liquid level b 1 in the chamber of the drainage body 4 and the liquid level dl at the outlet will also be maintained by the vacuum negative pressure. Under the condition of working vacuum degree, the liquid level here will be stabilized near the Point b 1, and the liquid level of the receiving hopper will be stabilized near the Point b. As the U-shaped parts of the inner chambers of the filling body 2 and the drainage body 4 are full of molten steel, the resultant force formed by the static pressure of the motel steel and the insoluble substance layer at the section cb of the inner chamber of the filling body 2 and the atmospheric pressure is balanced with the pressure of the molten steel at the section cd, and the molten steel will not flow. In a similar way, the resultant force formed by the static pressure of the motel steel at the section c id 1 of the inner chamber of the drainage body 4 and the atmospheric pressure is balanced with the pressure of the molten steel at the section c ‘b 1, and the molten steel also will be stable and not flow. At this moment, refining treatment is stopped, and the vacuum treatment warehouse is isolated from the atmospheric environment and continues to keep the vacuum. Furthermore, this process is realized naturally without manual control. During refining treatment, the refining treatment starts along with the injection of the molten steel to be treated. As the molten steel 12 is injected into the receiving hopper 1, the molten steel liquid level rises and is higher than the liquid level of Point b, and the pressure difference formed by the pressure of the molten steel higher than the part of Point b breaks the original balance to prompt the molten steel to flow from the inner chamber of the filling body 2 to the vacuum treatment warehouse 3. After being broken and exposed for degassing in the falling process in the warehouse, the molten steel is gathered at the lower part of the vacuum treatment warehouse 3. As the refining continues, the refining molten steel is continuously gathered to make the molten steel liquid level in the warehouse higher than the position b 1, and the pressure difference formed by the pressure of the molten steel higher than the part of Point b 1 breaks the original balance to generate discharge power so as to discharge the molten steel after refining treatment. The technological operation of the whole process is very simple and easy, and the process is stable and easy to be controlled.

Further design: as the insoluble substance of the molten steel is difficult to be avoided, these insoluble substance oxides will have many adverse influences on the further refining treatment. However, the structure and overall design of the receiving hopper designed by the invention can realize the purpose of avoiding the insoluble substance completely and thoroughly without any manual control operation. Through fit design of the injection flow of the steel ladle and flux in the inner chamber of the filling bod, we can effectively control that the liquid level does not exceed the upper limit a of the molten steel liquid level required by the design when the receiving hopper receives the primary melting molten steel injected by the steel ladle, so as to ensure that there is a thick enough insoluble substance layer in the receiving hopper 1 and on the molten steel 12 for molten steel heat preservation and anti-oxidation covering and protection. Similarly, we can effectively control that the refining treatment molten steel is not stored in the vacuum treatment warehouse 3 through the fit design of the flux of the inner chamber of the drainage body 4 and the refining treatment flow, and that the molten steel can be discharged at any time so that the liquid level in the warehouse does not exceed the Point al, so as to ensure that the space of the vacuum treatment warehouse 3 is not filled with the molten steel and ensure continuous vacuum refining treatment.

Under the refining condition, the increase of the injection speed of the steel ladle will raise the liquid level of the molten steel 12 in the receiving hopper (but it will not exceed the Point a, and this is determined by flux design). The increase of pressure caused by the rise of the liquid level will increase the flow speed of the molten steel in the filling body 2. As the structure design has determined that the molten steel liquid level will not exceed the Point a, even the molten steel will not overflow, so as to ensure normal refining treatment. The excessive insoluble substances will be very natural to be overflowed and discharged from the overflow port of insoluble substance. Even though there are a lot of insoluble substances, the density of the insoluble substances is much smaller than that of the molten steel, and the thickness of insoluble substance layer will increase to reduce the pressure strength at the injection side of the molten steel of the filling body 2. When the thickness of insoluble substance layer reaches a certain value (the lower limit reaches the Point b, or the thickness of insoluble substance layer is eb), the power for making the molten steel flow cannot be provided, the insoluble substances injected sequentially only can be discharged from the overflow port 7 of insoluble substance, and they will not enter the vacuum treatment warehouse 3. So, the receiving hopper will play a very good role in separating the molten steel and the insoluble substances, and the insoluble substances can be avoided completely and thoroughly. Furthermore, any manual operation is unnecessary in this process.

Further design: Vacuum exposure condition and vacuum remaining time of the molten steel are the determining factors of affecting the degassing effect, and this is just the core problem that the degassing effect of the existing equipment is unsatisfactory. For solving this problem to fully play the vacuum performance, the baffle body 9 is set in the vacuum treatment warehouse 3 in the invention. The baffle body 9 is capable of slowing down the falling of the molten steel, winding the falling path and prolonging the process, so s to prolong the vacuum remaining time of the molten steel. The other function of the baffle body 9 is to break the flow of molten steel and disperse it so as to fully expose the molten steel and create good conditions for removing the harmful gas.

For the further design, electrical heating elements 10 can be embedded in the refractory linings 10 in the inner chambers of the receiving hopper 1, the filling body 2, the vacuum treatment warehouse 3 and the drainage body. The heat produced by the electrical heating elements 10 is used for compensating the heat loss in the treatment process to prevent condensation to stabilize the temperature of the molten steel, so as to ensure normal refining treatment. The electrical heating elements 10 are made of materials not polluting the molten steel.

The invention can realize vacuum continuous production. The frequent operation of breaking vacuum and repeated vacuum extraction and vacuum breaking by air inflation is unnecessary, and the technological operation is simple. The pressure remaining sealing of the vacuum treatment warehouse is very natural to be realized by the structure design, the process is stable and reliable without manual operation, the lift gas is not used, the workload of the vacuum pump can be reduced greatly, and the energy consumption is significantly reduced. The invention can provide good vacuum refining conditions which is difficult to be provided by the existing equipment for the molten steel: \textcircled{1} good exposition conditions, \textcircled{2} higher vacuum degree (guaranteed by good sealing conditions and low extraction burden) and \textcircled{3} longer vacuum remaining time. So, high purification treatment requirements that the existing equipment is difficult to reach can be realized.

1. Vacuum degassing device of pump valve, comprising a receiving hopper, a filling body, a vacuum treatment warehouse and a drainage body, which are connected orderly, inner chambers thereof are connected with each other, and all parts are in tight and fixed connection.

2. The vacuum degassing device of pump valve according to claim 1, wherein the receiving hopper is of asymmetric and conical structure with an opening at one side, and it is used for discharging the excessive insoluble substances.

3. The vacuum degassing device of pump valve according to claim 1, wherein the inner chambers of the filling body and the drainage body are of U-shaped structure, the inner chambers at two sides are designed with liquid level difference h (h«1.48 m), pressure retaining sealing liquid injection devices be and d iC with enough height are set below a liquid level line at the liquid level of Point b of the receiving hopper and the liquid level of Point d1 of the drainage body, and they are used for realizing pressure retaining sealing of the vacuum treatment warehouse.

4. The vacuum degassing device of pump valve according to claim 1, wherein the receiving hopper, the filling body, the vacuum treatment warehouse and the drainage body are equipped with refractory linings, in which electrical heating elements are embedded.

5. The vacuum degassing device of pump valve according to claim 1, wherein the vacuum treatment warehouse is of L-shaped structure, its vertical vacuum part is a splash zone, and a baffle body is set up here; its horizontal part is a non-splash zone, and a vacuum extraction opening is set up here
